(19) United States
(12) Patent Application Publication
(10) Pub. No.: US 2020/0307355 A1
(43) Pub. Date: Oct. 1, 2020

(54) ELECTRIC HEATING DEVICE WITH GROUNDING MEANS

(71) Applicant: Valeo Systemes Thermiques, Le Mesnil Saint Denis Cedex (FR)

(72) Inventors: Yann Couapel, Le Mesnil Saint Denis Cedex (FR); Erwan Gogmos, Le Mesnil Saint Denis Cedex (FR)

(73) Assignee: Valeo Systemes Thermiques, Le Mesnil Saint Denis Cedex (FR)

(21) Appl. No.: 16/765,653

(22) PCT Filed: Dec. 10, 2018
(86) PCT No.: PCT/FR2018/053172

§ 371 Date: May 20, 2020

(30) Foreign Application Priority Data
Dec. 19, 2017 (FR) 1762531

(51) Int. Cl. B60H 1/22; F24H 3/04; F24H 9/18; F24H 9/02

(52) U.S. Cl. CPC B60H 1/2225; F24H 3/0447; F24H 9/02; F24H 9/1863; F24H 3/0452

(57) ABSTRACT

A heating device 1 for an air-conditioning unit, said heating device 1 comprising a heating body 2 supplied with current in order to heat an airflow passing through said heating body 2, the heating body 2 comprising heating elements that are flowed through by said current and located in tubes 4 that are electrically insulated from the heating elements, said heating elements being controlled via a distribution unit 3, the heating device 1 comprising means for grounding a plurality of metal elements that are distributed in the heating body 2 and the distribution unit 3.

This device is characterized in that said grounding means consist of a grounding circuit passing through the heating body 2 and the distribution unit 3, at least one part of said grounding circuit being integrated into a protective housing 8 of the distribution unit 3.

### FIELD OF THE INVENTION

The invention relates to a heating device for an air-conditioning unit, comprising grounding means. The invention also relates to an air-conditioning unit comprising such a heating device. It will be particularly applicable in the field of motor vehicles.

### PRIOR ART

Electric heating devices that are intended to be integrated into vehicle air-conditioning units are known. These are either additional radiators, combined with heating radiators through which a heat transfer fluid flows, in vehicles with an internal combustion engine, or main radiators, in electric or hybrid vehicles.

Such heating devices comprise a heating body accommodating heating units that are provided with heating elements that are supplied with electric current by electrodes. For electrical safety reasons, it may be necessary to isolate the heating elements and their supply electrodes from the outside. To this end, the heating units comprise tubes inside which the heating elements and their electrode are located, the inner surface of the tube being provided with an electrically insulating layer in order to isolate the heating elements and their electrode.

These heating devices comprise a distribution unit capable of controlling the current flowing in the heating units, in particular via an electronic board.

Several elements belonging to both the heating body and the distribution unit necessarily have to be grounded for safety reasons.

As a reminder, ground is the conductive part of electrical equipment likely to be touched by a person, which is not normally powered but may become so in the event of an insulation fault with the active parts of this equipment.

All of the metal frames of the heating device thus have to be grounded for safety reasons. In motor vehicles with metal bodywork, the bodywork is used as electrical ground.

It is common to connect each metal element of the heating device to a stud for example, which is itself connected to ground, that is to say the bodywork in the example of the motor vehicle. These are in particular metal elements likely to be in contact with high current in the event of a current leak.

In particular, in the case of the heating device, for each metal element to be connected to ground, there is an additional conductive component generally placed in an imprint formed in a plastic component belonging to the heating device. This additional conductive component is connected, on the one hand, to ground via a braid, and is connected, on the other hand, to the metal element via a metal connecting component, or a braid.

This involves the presence of a large number of elements, and an increase in the connections, often corresponding to ground cables, between each metal element and ground. These connections are sometimes difficult to integrate, given the limited space available inside the heating device. Moreover, there is a risk of interference between these connections and others present within the heating device.

### SUMMARY OF THE INVENTION

The present invention aims to overcome the various drawbacks set out above through a heating device allowing grounding of its metal elements by way of a simple and easy structure within the heating body and the distribution unit, and in which there is no risk of interference.

This aim is achieved by virtue of a heating device for an air-conditioning unit comprising, as is conventional, a heating body supplied with current in order to heat an airflow passing through said heating body, the heating body comprising heating elements that are flowed through by said current and located in tubes that are electrically insulated from the heating elements, said heating elements being controlled via a distribution unit, the heating device comprising means for grounding a plurality of metal elements that are distributed in the heating body and the distribution unit.

This device is mainly characterized in that said grounding means consist of a grounding circuit passing through the heating body and the distribution unit, at least one part of said grounding circuit being integrated into a protective housing of the distribution unit.

The main idea of this invention is that of using the protective housing of the distribution unit to route the grounding circuit.

Using such a housing makes it possible to eliminate the use of plastic components in which the imprints were formed.

The housing of the distribution unit performs several functions, namely the main function of protecting the distribution unit, but also the basic insulation function for the routing of the grounding circuit.

Since this part of the circuit is “integrated” into the housing, this means that it does not run through the enclosure of the distribution unit. There are no longer any grounding cables running through the distribution unit and that risk interfering with other components. The grounding circuit is thus simplified.

According to the various embodiments of the invention, which may be taken together or separately:
said at least one part of said grounding circuit is made from an electrically conductive aluminum, steel or brass metal material.
said at least one part of the grounding circuit consists of a connection bar arranged within the housing: this bar is therefore integrated into the housing, and passes through the distribution unit via the housing. There is no longer a multitude of ground cables, but a single ground connection bar that runs through the distribution unit. Therefore, there is no longer any specific wiring to be carried out when mounting the distribution unit, which allows a considerable time saving. In addition, handling is made easier, since there is ultimately only one component to handle, that is to say the housing, when installing the grounding circuit.
said protective housing is made from an electrically insulating plastic material.
said at least one part of the grounding circuit is overmolded into the housing and forms an insert: this overmolding makes it possible to make part of the grounding circuit invisible, and to protect this part from the other components arranged in the distribution unit. Specifically, overmolding prevents any contact between this part of the circuit and the other components. Overmolding also makes it possible to avoid any risk of the connection bar detaching due to the vibrations of the embedded heating device. Advantageously, the bar forms an insert in the housing, thereby making it possible to stiffen the protective housing. In this way, it is possible to combine both a grounding function and a function of stiffening the protective housing, by way of a single bar. This pooling of functions also makes it possible to contribute to the compactness of the distribution unit.
the heating device comprises a metal heat sink plate through which the grounding circuit passes.
said bar comprises:
   a first end electrically connected to the plate;
   a central part overmolded into the housing;
   a second free end, overmolded at least partially into the housing, and connected to a grounding stud.
said bar is integral with the plate and comprises:
   a central part overmolded into the housing;
   a free end, overmolded at least partially into the housing, and connected to a grounding stud.
the bar and the plate may be connected in particular but not exclusively by clinching/deformation or by way of an intermediate component such as a screw or a rivet.
the bar extends orthogonally to the plate.
the distribution unit comprises an electronic control board on which heat-releasing components are fixed, said plate being in contact with these components: these are in particular transistors.
the bar extends over substantially the entire length of the electronic board and at a distance from the electronic board: this makes it possible to avoid any contact with the components fixed on the electronic board.
there is only one grounding circuit running through the heating body and the distribution unit and formed by placing said metal elements in series through direct contact between said metal elements: the circuit is formed by a chain of metal elements to be grounded. In this chain, the metal elements touch one another directly in pairs, so as to ensure electrical continuity. There is thus a sequence of metal elements in series within the heating device, forming the grounding circuit. Each metal element forms a link of the electrical chain.
the heating device comprises an electrical connection element for connection between the heating body and said plate.
the tubes are electrically connected to one another via heat sinks that are electrically conductive, the grounding circuit passing successively through these tubes and these heat sinks.
said electrical connection element is arranged between the plate and a tube located at one end of the heating body and called end tube.
said electrical connection element consists of a flexible blade clip capable of ensuring electrical continuity between said end tube and said plate.

The invention also relates to an air-conditioning unit comprising a heating device as described above.

### PRESENTATION OF THE FIGURES

The invention will be better understood, and other aims, details, features and advantages thereof will become more clearly apparent from the following detailed explanatory description of at least one embodiment of the invention, which is provided by way of a purely illustrative and non-limiting example, with reference to the appended schematic drawings.

In these drawings:

FIG. 1 illustrates a heating device according to the invention in perspective,

FIG. 2 shows a grounding bar connected to a heat sink plate in perspective,

FIG. 3 shows the grounding bar of FIG. 5 molded into a protective housing of the distribution unit in perspective,

FIG. 4 is a sectional view of FIG. 3 at the grounding bar.

### DETAILED DESCRIPTION

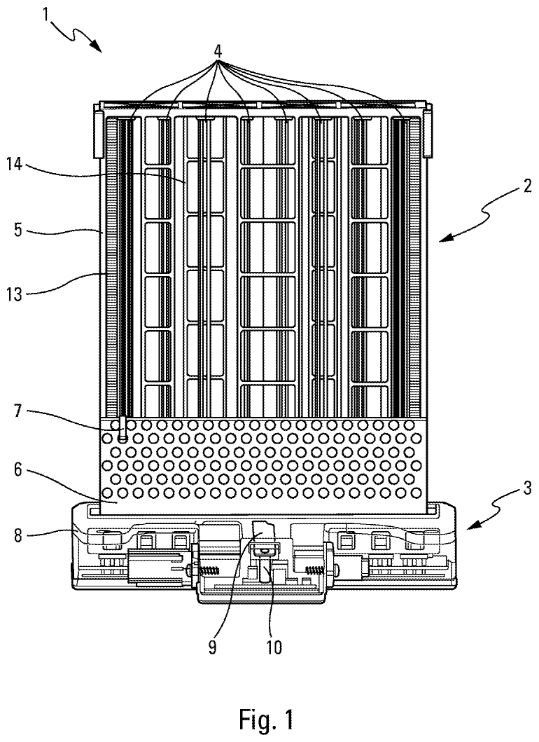

With reference to FIG. 1, the invention relates to an electrical heating device 1. This is for example a heating device 1, said to be high voltage, that is to say intended to be supplied by direct current (DC) or alternating current (AC) having a voltage greater than 60 V, in particular between 60 and 1000 V, more particularly between 180 and 600 V, and/or allowing a heating power to be output into the air or a consumed electric power greater than 2 kW, in particular between 2 kW and 10 kW.

Said heating device 1 comprises a heating body 2 supplied with electric current in order to heat an airflow passing through said heating body 2.

Said heating body 2 in this case has a substantially parallelepipedal configuration extending on the surface. It is intended to be positioned transverse to the airflow to be heated. More precisely, said airflow is intended to be oriented perpendicular to said heating body 2, that is to say perpendicular to the plane of FIG. 1.

The heating body 2 comprises heating elements (not shown) that are flowed through by said current. The heating elements are for example PTC (positive temperature coefficient) effect resistors.

The heating elements are located inside metal tubes 4. In order to avoid any electrical contact between the heating elements and the tubes 4, a layer of electrically insulating and thermally conductive material coats the inner surface of the tubes 4.

Each tube 4/heating elements assembly forms what is called a heating unit.

Said heating units are selectively supplied with current. This is understood to mean that each heating unit is supplied with current independently of the others and may therefore be flowed through by a current that is different, in particular in terms of its magnitude, from the current flowing through the other heating units. The value of the current involved in this case is in particular the value of the average current or of the effective current.

The heating body 2 may comprise heat sinks 13, for example fins, in thermal contact with the tubes 4. The heat sinks 13 are in particular positioned between said tubes 4. For the sake of clarity, only some heat sinks 13 extending from the end tubes 4 have been shown, so as not to overload FIG. 1.

Said heating body 2 comprises a frame 5, in particular made of plastic, accommodating said heating units and used to hold said tubes 4.

Intermediate bars 14 are also provided between the tubes 4 in order to hold them in position.

Preferably, the heating device 1 furthermore comprises a distribution unit 3 able to control the current flowing in said heating body 2.

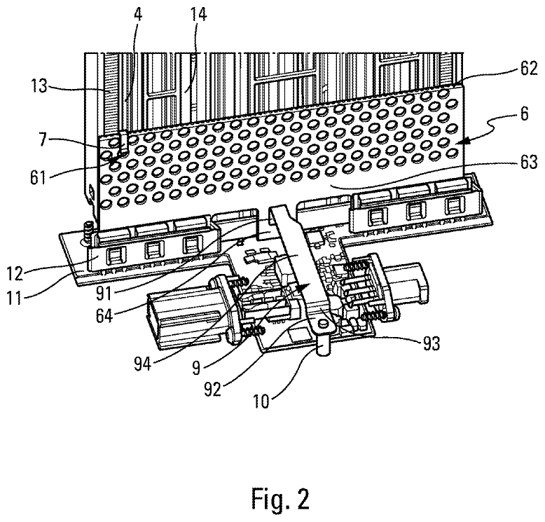

Said distribution unit 3 is advantageously configured so as to drive the current being supplied to the heating body 2, in particular the various heating units, for example using driven switches, making it possible to control a respective flow of current in each of the heating units. These are in particular transistors 12, for example MOSFETs or IGBTs, operating in particular through pulse width modulation. These transistors 12 are in particular visible in FIG. 2 and are mounted on a T-shaped electronic board 11 that therefore has a central axis of symmetry.

Said distribution unit 3 comprises a housing 8, visible in FIGS. 1, 3 and 4, which completely covers said electronic board 11 and which comprises a connection face 83 used for mounting and/or mechanically fixing the heating body 2. This housing 8 is preferably made from a plastic having electrically insulating properties and is obtained by molding.

During operation of the heating elements, the transistors 12 release a considerable amount of heat. In order to avoid any overheating within the housing 8, a heat sink plate 6 is provided in the heating device 1. This plate 6 consists of a perforated metal sheet, positioned in a plane parallel to the plane of the heating body 2, and located in front of the tubes 4 such that the airflow passing through the heating body 2 also passes through this perforated plate 6. This plate 6 thus helps to heat the airflow.

The plate 6 consists primarily of a perforated body 63 from which tabs extend (these being hidden by the transistors 12 in FIG. 2) that are capable of coming into contact with the transistors 12 so as to draw the calories emanating from the transistors 12. The plate 6 thus heats up, via the transistors 12, and is then cooled via the airflow.

In such a heating device 1, it is essential that the metal elements are grounded, so as to make them electrically safe.

To this end, there is a grounding circuit that passes through the entire heating device 1, such that each metal element is able to be connected thereto. In particular, this grounding circuit consists of a series of metal elements that are positioned in series and in direct contact in pairs, and thus forming the circuit.

At the heating body 2, the tubes 4 and the heat sinks 13 and the intermediate bars 14 are metal. In the configuration of the heating device 1 according to the invention, the heat sinks 13 are all connected to a tube 4 through direct contact, and the heat sinks 13 of two adjacent tubes 4 meet and are also in direct contact, or meet at an intermediate bar 14. Therefore, the entire row of tubes 4, heat sinks 13 and intermediate bars 14 are in electrical contact with one another, and the grounding circuit thus passes through all of the tubes 4, the heat sinks 13 and the intermediate bars 14 of the heating body 2.

At the output of this row of tubes 4, heat sinks 13 and intermediate bars 14, an electrical connection element 7 is arranged between an end tube 4 and the perforated plate 6, as illustrated in particular in FIGS. 1 and 2. This electrical connection element 7 ensures electrical continuity between the tubes 4 and the perforated plate 6.

For example, this electrical connection element 7 consists of a metal clip 7 arranged straddling the perforated plate 6, and provided with a flexible blade bearing on the end tube 4.

Any other type of electrical connection element 7 may be contemplated, as long as it provides electrical continuity between the plate 6 and the tubes 4.

The grounding circuit passes through this electrical connection element 7, and then through the perforated plate 6.

The grounding circuit then continues through a metal bar 9, for example made of aluminum, steel or brass, passing over the entire electronic board 11 along its axis of symmetry, as is visible in particular in FIG. 2. This bar 9 extends orthogonally from the perforated plate 6.

The bar 9 comprises:
a first end 91 fixed to the perforated plate 6
a central part 94 extending over the electronic board 11
a second free end 92 connected to a grounding stud 10.

More precisely, the first end 91 consists of a tab with a profile perpendicular to the central part 94. It is welded for example to a central tongue 64 extending from the perforated body 63 of the plate 6. It may be fixed by any other means for ensuring electrical continuity between the perforated plate 6 and the bar 9.

Even more precisely, the second end 92 comprises an orifice into which the grounding stud 10 is bolted. The bar 9 comprises a shoulder 93 located just upstream of the second end 92.

The grounding circuit thus ends at the stud 10. In the case of a motor vehicle for example, this stud 10 will be connected to the bodywork of the vehicle, which forms the grounding reference.

The grounding circuit may also take the opposite path, that is to say passing through the stud, the bar, the plate, the clip, and then the row of tubes/fins/intermediate bars.

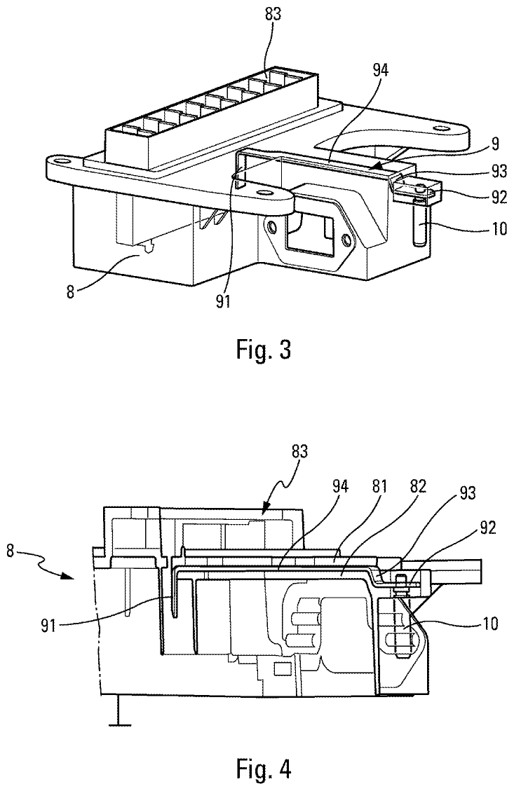

Advantageously, this bar 9 is overmolded into the protective housing 8, as illustrated in FIGS. 3 and 4. Such overmolding also makes it possible to position the bar 9 at a distance from the electronic board 11 in order to avoid any contact with the components of the board 11.

In particular, the central part 94 and the second end 92 of the bar 9 are fully embedded in the material of the protective housing 8. The first end 91 for its part is flush with the housing 8. As illustrated in FIG. 4, there is an upper layer of plastic 81 and a lower layer of plastic 82 belonging to the protective housing 8 and sandwiching the bar 9.

The bar 9 thus consists of an insert, in particular used to stiffen the housing 8. Thus, in addition to its grounding function, the bar 9 is used to consolidate the housing 8.

The stud 10 projects from the protective housing 8 in order to be accessible for connection thereof to ground.

In this way, there is no particular wiring to be carried out within the heating device 1 in order to ground the metal elements. All of the metal elements of the heating device 1 come into contact with one another, in series, so as to form a single grounding circuit passing through the heating device 1.

The invention also relates to an air-conditioning unit comprising a heating device 1 as described above. Said air-conditioning unit comprises a body for the flow of the airflow, inside which body said heating device 1 is located.

With regard to the above description, the optimum dimensional relationships for the parts of the invention, including variations in size, materials, shapes, function and modes of operation, assembly and use, are considered to be apparent and obvious to those skilled in the art, and all relationships equivalent to what is illustrated in the drawings and what is described in the specification are intended to be included in the present invention.

1. A heating device for an air-conditioning unit, said heating device comprising:
a heating body supplied with current in order to heat an airflow passing through said heating body,
the heating body comprising heating elements that are flowed through by said current and located in tubes that are electrically insulated from the heating elements, said heating elements being controlled via a distribution unit; and
means for grounding a plurality of metal elements that are distributed in the heating body and the distribution unit,
wherein said grounding means consist of a grounding circuit passing through the heating body and the distribution unit, at least one part of said grounding circuit being integrated into a protective housing of the distribution unit.

2. The heating device as claimed in claim 1, wherein said at least one part of the grounding circuit is made from an electrically conductive aluminum, steel or brass metal material.

3. The heating device as claimed in claim 1, wherein said at least one part of the grounding circuit consists of a connecting bar arranged within the housing.

4. The heating device as claimed in claim 1, wherein said protective housing is made from an electrically insulating plastic material.

5. The heating device as claimed in claim 1, wherein said at least one part of the grounding circuit is overmolded into the housing and forms an insert.

6. The heating device as claimed in claim 1, further comprising a metal heat sink plate through which the grounding circuit passes.

7. The heating device as claimed in claim 6, wherein said bar comprises:
a first end electrically connected to the plate,
a central part overmolded into the housing,
a second free end overmolded at least partially into the housing and connected to a grounding stud.

8. The heating device as claimed in claim 6, wherein said bar is integral with the plate and comprises:
a central part overmolded into the housing,
a free end overmolded at least partially into the housing and connected to a grounding stud.

9. The heating device as claimed in claim 7, wherein the bar extends orthogonally to the plate.

10. The heating device as claimed in claim 6, wherein the distribution unit comprises an electronic control board on which heat-releasing components are fixed, said plate being in contact with these components.

11. The heating device as claimed in claim 10, wherein the bar extends over substantially the entire length of the electronic board and at a distance from the electronic board.

12. An air-conditioning unit comprising:
a heating device comprising:
a heating body supplied with current in order to heat an airflow passing through said heating body,
the heating body comprising heating elements that are flowed through by said current and located in tubes that are electrically insulated from the heating elements, said heating elements being controlled via a distribution unit; and
means for grounding a plurality of metal elements that are distributed in the heating body and the distribution unit,
wherein said grounding means consist of a grounding circuit passing through the heating body and the distribution unit, at least one part of said grounding circuit being integrated into a protective housing of the distribution unit.

13. A heating device comprising:
a heating body supplied with current in order to heat an airflow passing through said heating body,
the heating body comprising heating elements that are flowed through by said current and located in tubes that are electrically insulated from the heating elements, said heating elements being controlled via a distribution unit; and
a grounding circuit for grounding a plurality of metal elements that are distributed in the heating body and the distribution unit,
the grounding circuit passing through the heating body and the distribution unit, at least one part of said grounding circuit being integrated into a protective housing of the distribution unit,
wherein the grounding circuit is formed by placing the plurality of metal elements in series through direct contact between said metal elements creating a chain of metal elements that touch each other in pairs to ensure electrical continuity.
